(19) United States
(12) Patent Application Publication
(10) Pub. No.: US 2011/0274448 A1
(43) Pub. Date: Nov. 10, 2011

(54) IMAGE PROCESSING APPARATUS, CHARGING DEVICE, AND CHARGING ROLLER CONTROL METHOD

(75) Inventors: Daisuke Yamashita, Shizuoka-ken (JP); Takeshi Watanabe, Kanagawa-ken (JP)

(73) Assignees: TOSHIBA TEC KABUSHIKI KAISHA, Tokyo (JP); KABUSHIKI KAISHA TOSHIBA, Tokyo (JP)

(21) Appl. No.: 13/096,154

(22) Filed: Apr. 28, 2011

Related U.S. Application Data
(60) Provisional application No. 61/331,153, filed on May 4, 2010.

(51) Int. Cl. G03G 15/02

(52) U.S. Cl. 399/31

(57) ABSTRACT

According to one embodiment, an image processing apparatus includes an image bearing member, a charging roller, a gap keeping member, a determining unit, and a driving unit. The gap keeping member comes into contact with an outer circumferential surface of the image bearing member and keeps a distance between the outer circumferential surface of the image bearing member and an electric resistance adjusting layer of the charging roller. The determining unit determines whether a contact section between the outer circumferential surface of the image bearing member and the gap keeping member is worn. The driving unit shifts, if the determining unit determines that the contact section is worn, a contact position between the outer circumferential surface of the image bearing member and the gap keeping member.

### CROSS-REFERENCE TO RELATED APPLICATION

This application is based upon and claims the benefit of priority from: U.S. provisional application 61/331,153, filed on May 4, 2010; the entire contents all of which are incorporated herein by reference.

### FIELD

Embodiments described herein relate generally to a technique for charging a photoconductive member of an image processing apparatus.

### BACKGROUND

In order to uniformly charge a photoconductive member of an image processing apparatus, a charging roller including a resistance adjusting layer such as a conductive resin layer or elastic layer on a circumferential surface of a conductive supporting member of metal or the like is used. As a charging system for the photoconductive member, there is a non-contact charging system.

An example of the non-contact charging system is explained. First, gap keeping members slightly larger than an outer diameter of the resistance adjusting layer of the charging roller are provided at both ends of the charging roller. When the photoconductive member and the gap keeping members come into contact with each other, small gaps are formed between the photoconductive member and the resistance adjusting layer. The charging roller discharges between the gaps to charge the photoconductive member.

Because of long-term use of the image processing apparatus, a photoconductive layer of the photoconductive member is worn by friction on a contact surface between the photoconductive member and the gap keeping members. This makes it difficult to keep a space distance between the photoconductive member and the resistance adjusting layer constant. When the space distance is not kept constant, the photoconductive member cannot be uniformly charged and shading unevenness appears in a formed image.

### DESCRIPTION OF THE DRAWINGS

FIG. 1 is a diagram of an example of an image processing apparatus;

FIG. 2 is a diagram of an arrangement example of devices in a first embodiment;

FIG. 3 is a diagram of an example of functional blocks in the first embodiment;

FIG. 4 is a flowchart for explaining a processing example in the first embodiment;

FIG. 5 is a diagram of an example of functional blocks in a second embodiment;

FIG. 6 is a diagram of an example of a current-voltage characteristic;

FIG. 7 is a flowchart for explaining a processing example in the second embodiment;

FIG. 8 is a diagram of an arrangement example of devices in a third embodiment;

FIG. 9 is a diagram of an example of functional blocks in the third embodiment; and

FIG. 10 is a flowchart for explaining a processing example in the third embodiment.

### DETAILED DESCRIPTION

In general, according to one embodiment, an image processing apparatus includes an image bearing member, a charging roller, a gap keeping member, a determining unit, and a driving unit. The charging roller charges the image bearing member. The gap keeping member comes into contact with an outer circumferential surface of the image bearing member and keeps a distance between the outer circumferential surface of the image bearing member and an electric resistance adjusting layer of the charging roller. The determining unit determines whether a contact section between the outer circumferential surface of the image bearing member and the gap keeping member is worn. The driving unit shifts, if the determining unit determines that the contact section is worn, a contact position between the outer circumferential surface of the image bearing member and the gap keeping member.

In embodiments explained below, the image processing apparatus detects wear of a contact surface between the photoconductive member and the gap keeping member. When the contact surface is worn, the image processing apparatus of each embodiment moves the gap keeping member to prevent charging unevenness and peeling of a photoconductive layer due to the wear.

The embodiments are explained below with reference to the accompanying drawings.

### First Embodiment

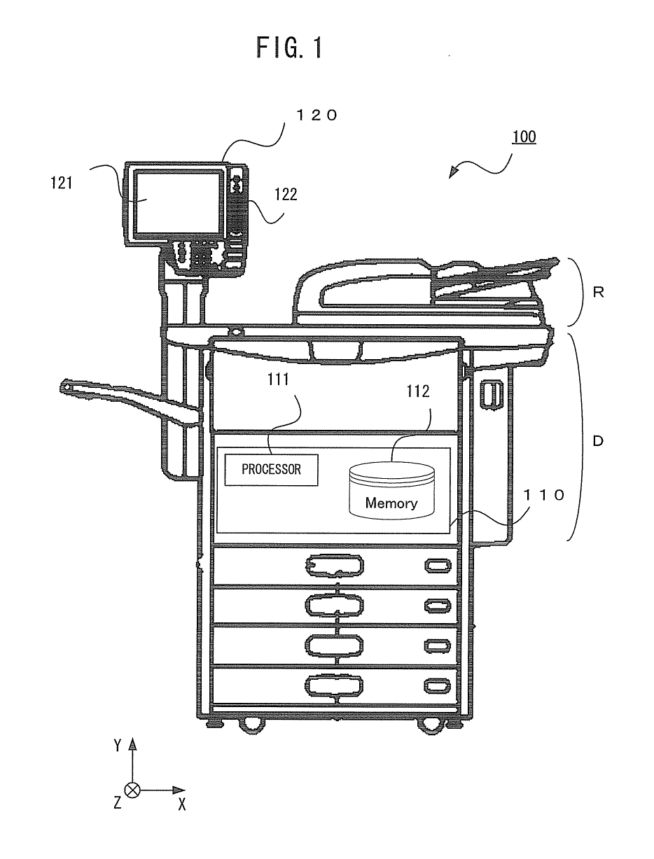

FIG. 1 is a diagram of an example of an image processing apparatus. An image processing apparatus 100 is an MFP (Multifunction Peripheral) having a copy function, a printer function, a scanner function, and a function of transmitting and receiving facsimiles and emails. The image processing apparatus 100 includes a control board 110 configured to collectively control hardware devices in the apparatus. The control board 110 includes a processor 111, which is an arithmetic processing device, and a memory 112 including a RAM (Random Access Memory), which is a volatile storage device, and a ROM (Read Only Memory) and a HDD (Hard Disk Drive), which are nonvolatile storage devices. Data or computer programs are stored in the memory 112.

The image processing apparatus 100 includes a control panel 120 including a keyboard 122 configured to receive an instruction from a user and a touch panel display 121 configured to display control content and receive an instruction from the user.

The image processing apparatus 100 includes an image reading unit R configured to scan and read images of a sheet document and a book document and an image forming unit D configured to form, on a sheet, a scan image generated by the image reading unit R and an image of electronic data created by a PC (Personal Computer) or the like.

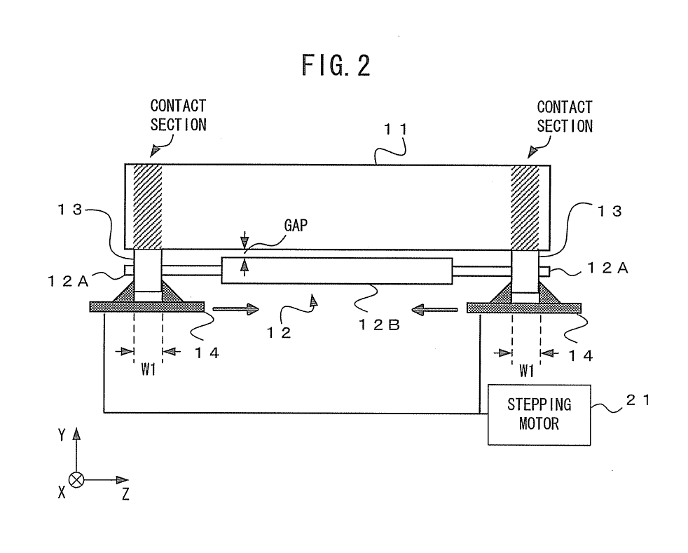

Devices such as a photoconductive member and a charging member included in the image forming unit D are shown in FIG. 2.

A charging member 12 is a charging roller including a shaft 12A and a resistance adjusting layer 12B (an electric resistance adjusting layer). Metal is used for the shaft 12A of the charging member 12. A conductive elastic member or resin composition is formed as the resistance adjusting layer 12B on a circumferential surface of the shaft 12A. Gap keeping members 13 for keeping a distance between the resistance adjusting layer 12B and a photoconductive layer of a photoconductive member 11 (an image bearing member, a photoreceptor, photosensitive drum) are provided at both ends of the shaft 12A. As a material of the gap keeping members 13, for example, resin having a resistance or an insulating property higher than that of the resistance adjusting layer 12B is used. Outer diameters of the gap keeping members 13 are slightly larger than an outer diameter of the resistance adjusting layer 12B. When the gap keeping members 13 and an outer circumferential surface of the photoconductive member 11 come into contact with each other, a gap is formed between the outer circumferential surface of the photoconductive member 11 and the resistance adjusting layer 12B. When a DC voltage or a voltage obtained by superimposing an AC voltage on the DC voltage is applied to the shaft 12A, near discharge occurs in the gap between the photoconductive member 11 and the resistance adjusting layer 12B and the photoconductive member 11 is charged. Satisfactory charging is obtained if a gap distance between the resistance adjusting layer 12B and the photoconductive member 11 is about 5 to 300 μm.

The image processing apparatus 100 includes moving members 14 configured to hold the gap keeping members 13 in a Z axis direction (a rotation axis direction of the photoconductive member 11 and the charging member 12). The moving members 14 obtain power from a stepping motor 21 to move the gap keeping members 13. The moving members 14 move the gap keeping members 13 such that a moving distance of the gap keeping members 13 is equal to or larger than a Z axis width W1 of the gap keeping members 13. The gap keeping members 13 move in the Z direction. However, the gap keeping members 13 may move in an inner side direction of the charging member 12 (an arrow direction shown in FIG. 2) or may move in an outer side direction of the charging member 12. Further, the gap keeping members 13 may move in the Z axis direction while keeping a distance between the gap keeping members 13 constant. If the gap keeping members 13 and the charging member 12 are fixed, the moving members 14 may move the gap keeping members 13 to the left or the right in the Z axis direction together with the charging member 12.

The shape of the moving members 14 is desirably a C shape as shown in FIG. 2 to prevent the gap keeping members 13 from shifting in the Z axis direction during the rotation of the charging member 12.

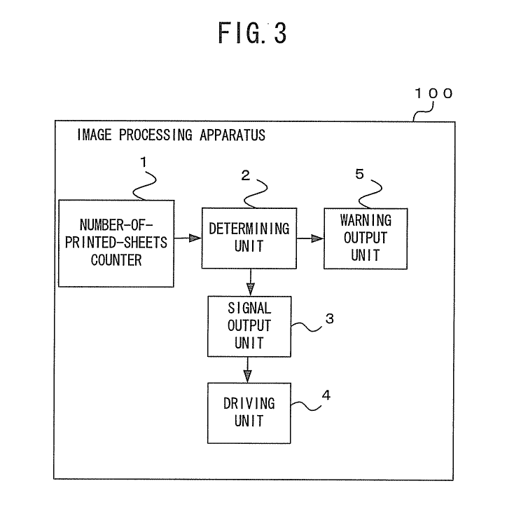

Main functional blocks of the image processing apparatus 100 for realizing the first embodiment are shown in FIG. 3. The image processing apparatus 100 includes a number-of-printed-sheets counter 1, a determining unit 2, a signal output unit 3, a driving unit 4, and a warning output unit 5 (a notifying unit).

The number-of-printed-sheets counter 1 increases a counter by one every time an image is printed on one sheet and stores a cumulative count value.

The determining unit 2 acquires a present cumulative count value of the number-of-printed-sheets counter 1 at any time or according to necessity and determines whether the acquired value exceeds a specified value (e.g., 10,000) set in advance. If the count value exceeds the specified value, the determining unit 2 transmits predetermined data or signal to the signal output unit 3.

The determining unit 2 counts how many times the gap keeping members 13 move. If the number of times of movement reaches a specified value (this specified value is calculated on the basis of a movable limit distance and a distance of one movement of the gap keeping members 13), the determining unit 2 outputs predetermined data or signal to the warming output unit 5.

If the signal output unit 3 acquires the output from the determining unit 2, the signal output unit 3 outputs a pulse signal to the driving unit 4. The driving unit 4 moves the gap keeping members 13 using the moving members 14.

If the warning output unit 5 acquires the output from the determining unit 2, the warning output unit 5 displays, on the control panel 120, a message for urging a user to replace a device.

Since the image processing apparatus 100 includes the warning output unit 5, for example, the image processing apparatus 100 can present a message for urging replacement of the photoconductive member 11 and the charging member 12 immediately before the gap keeping members 13 and the resistance adjusting layer 12B come into contact with each other if the gap keeping members 13 move to the inner side in order or immediately before the gap keeping members 13 project more than the outer side of the shaft 12A if the gap keeping members 13 move to the outer side in order.

Correspondence between the functional blocks shown in FIG. 3 and the hardware shown in FIGS. 1 and 2 is explained. The number-of-printed-sheets counter 1 is realized by the control board 110 (the processor 111 and the memory 112) (if sheets are not set as targets of counting and input and output of electronic data are set as targets of counting). The determining unit 2 is realized by the control board 110 (the processor 111 and the memory 112).

The signal output unit 3 is realized by a PLD (Programmable logic device) configured on the control board 110. The driving unit 4 is realized by the stepping motor 21 and the moving members 14. The warning output unit 5 is realized by the control panel 120. The number-of-printed-sheets counter 1 and the determining unit 2 are realized by the processor 111 loading a computer program stored in a nonvolatile storage area of the memory 112 in advance to a volatile storage area of the memory 112 and executing an arithmetic operation of the loaded computer program.

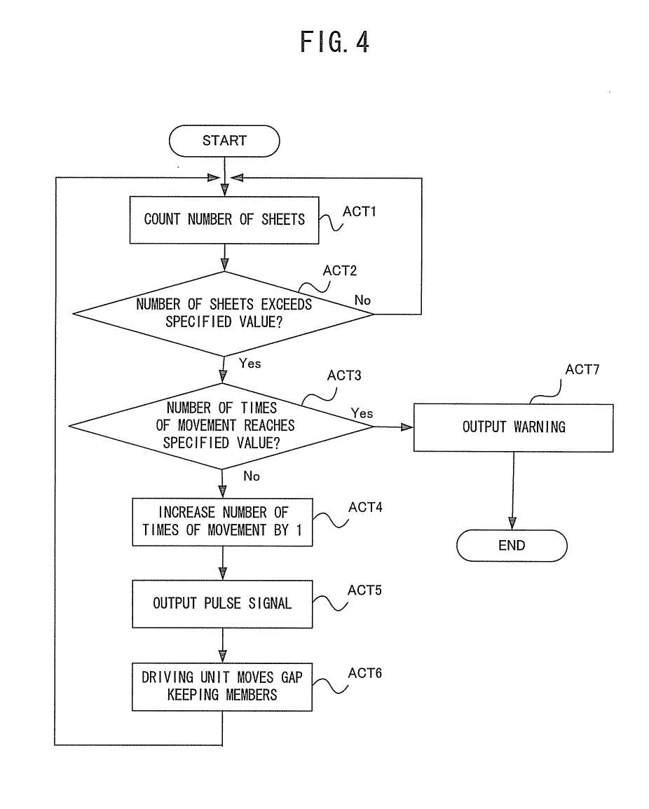

FIG. 4 is a flowchart for explaining an example of the operation of the image processing apparatus 100.

The number-of-printed-sheets counter 1 counts the number of printed sheets and stores a cumulative count value in the storage area of the memory 112 (ACT 1). The determining unit 2 acquires a count value and a specified value from the memory 112 sequentially or at every fixed time and compares the specified value and the count value (ACT 2). If the count value does not exceed the specified value (No in ACT 2), the processing returns to ACT 1. If the count value exceeds the specified value (Yes in ACT 2), the determining unit 2 clears the cumulative count to zero and, at the same time, acquires the number of times of movement and a specified value of the number of times of movement from the memory 112 and determines whether the number of times of movement reaches the specified value (ACT 3). If the number of times of movement reaches the specified value (Yes at ACT 3), the warning output unit 5 displays a message for urging replacement of a device on the touch panel display 121 of the control panel 120 (ACT 7).

On the other hand, if the number of times of movement does not reach the specified value (No in ACT 3), the determining unit 2 increases a variable value of the number of times of movement stored in the memory 112 by one (ACT 4). The signal output unit 3 outputs a pulse signal to the driving unit 4 (ACT 5). The driving unit 4 moves the gap keeping members 13 according to the received pulse signal (ACT 6). Thereafter, the processing returns to ACT 1.

In the example explained above, if the number of printed sheets exceeds the specified value, the determining unit 2 determines that contact sections are worn. However, if a cumulative operation time of the image processing apparatus exceeds a fixed period, the determining unit 2 may determine that the contact sections are worn.

By adopting such a configuration, it is possible to keep an amount of wear of the photoconductive layer at an amount equal to or smaller than a fixed amount. The gap between the photoconductive member and the resistance adjusting layer is kept. It is possible to prevent charging unevenness.

### Second Embodiment

In a second embodiment, specified values of an electric current and a voltage between a charging member and a photoconductive member are stored in an image processing apparatus in advance. The image processing apparatus measures a current value and a voltage value between the charging member and the photoconductive member at every number of printed sheets set in advance, for example, 10,000. If a measurement result deviates from the specified values, the image processing apparatus determines that wear of a photoconductive layer is worsened and performs movement control for gap keeping members.

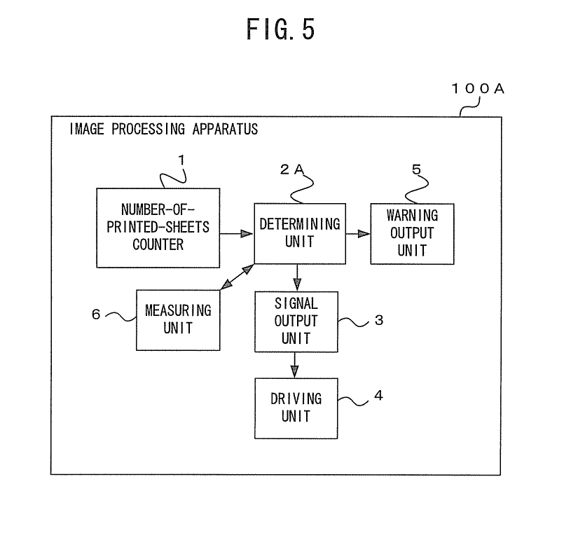

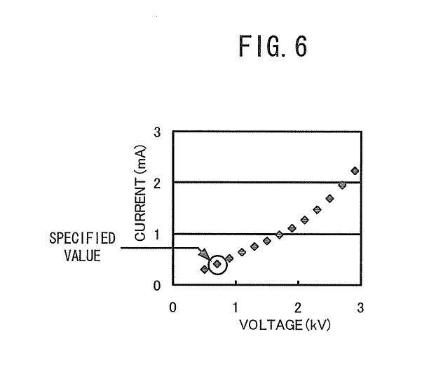

A block diagram of the image processing apparatus according to the second embodiment is shown in FIG. 5. An image processing apparatus 100A includes a measuring unit 6 (e.g., an ammeter and a voltmeter) configured to measure an electric current and a voltage between the charging member 12 and the photoconductive member 11. In addition to the function of the determining unit 2 explained in the first embodiment, a determining unit 2A acquires a measurement result of the measuring unit 6 and determines, on the basis of specified values stored in the memory 112 and the acquired measurement result, whether measured values are within specified ranges. The specified values of the electric current and the voltage may be, for example, values (initial values) measured before the shipment of the image processing apparatus 100A or design values of a current-voltage characteristic shown in FIG. 6 may be adopted as the specified values. Components other than the components explained above are the same as those in the first embodiment (see FIGS. 1 and 2).

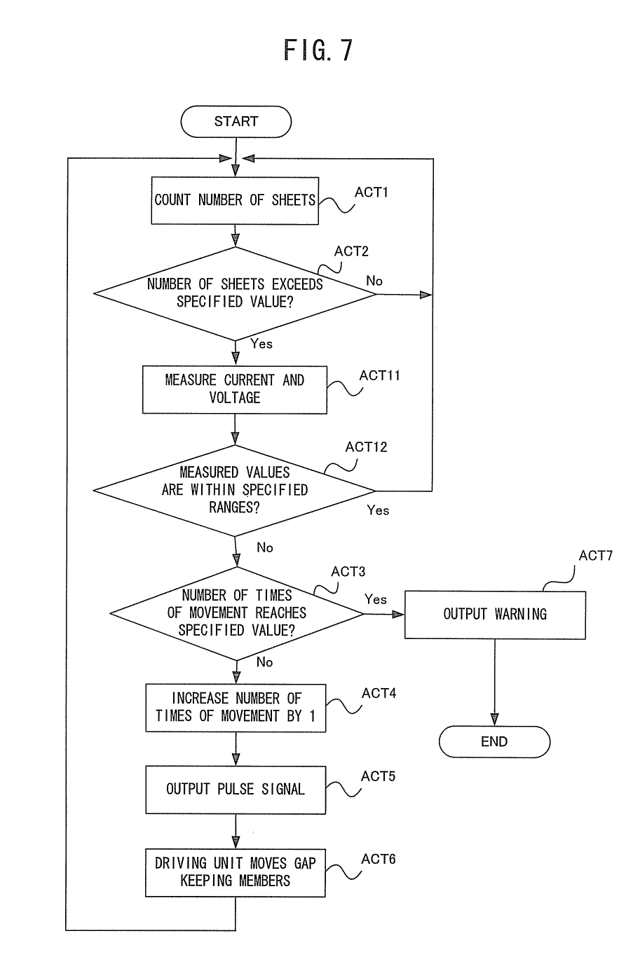

An operation example of the image processing apparatus 100A is shown in a flowchart of FIG. 7. If it is determined in ACT 2 that the number of printed sheets exceeds the specified value (Yes in ACT 2), the measuring unit 6 measures an electric current and a voltage between the charging member 12 and the photoconductive member 11 (ACT 11). The determining unit 2A acquires measured values from the measuring unit 6 and determines, on the basis of the measured values and the specified values stored in the memory 112, whether the measured values are within the specified ranges (ACT 12). In ACT 12, the determining unit 2A calculates differences between the measured values and the specified values and compares difference values and thresholds to determine whether the measured values are within the specified ranges. If the determining unit 2A determines that the measured values are within the specified ranges (YES in ACT 12), the processing returns to ACT 1. On the other hand, if the determining unit 2A determines that the measured values are outside the specified ranges (No in ACT 12), the processing proceeds to the determination of the number of times of movement in ACT 3.

Acts other than the acts explained above are the same as those in the first embodiment. In the above explanation, the measuring unit 6 measures the electric current and the voltage. However, the measuring unit 6 may measure only one of the electric current and the voltage. In this case, the determining unit 2A performs the determination concerning only a target (one of a current value and a voltage value) measured by the measuring unit 6.

In the example explained above, it is explained that the operation in ACT 3 and subsequent acts is performed if the count of the number of sheets exceeds the specified value (see ACT 1 and ACT 2). However, first power-on of the image processing apparatus in the day or return from a sleep state of the image processing apparatus may be set as a trigger for the operation in ACT 3 and subsequent acts. The count of the number of sheets, the power-on, and the return from sleep may be combined and set as a trigger for the operation.

### Third Embodiment

A photoconductive member before use has a gloss on a surface of a photoconductive layer. However, because of long-term use of the photoconductive member, on the photoconductive layer surface of the photoconductive member in contact with gap keeping members, a contact surface gradually wears and the gloss fades.

An image processing apparatus according to a third embodiment detects a density of reflection from the photoconductive layer surface using optical sensors and determines, if a detection result deviates from a specified value, that the wear of the photoconductive layer is worsened and performs movement control for the gap keeping members.

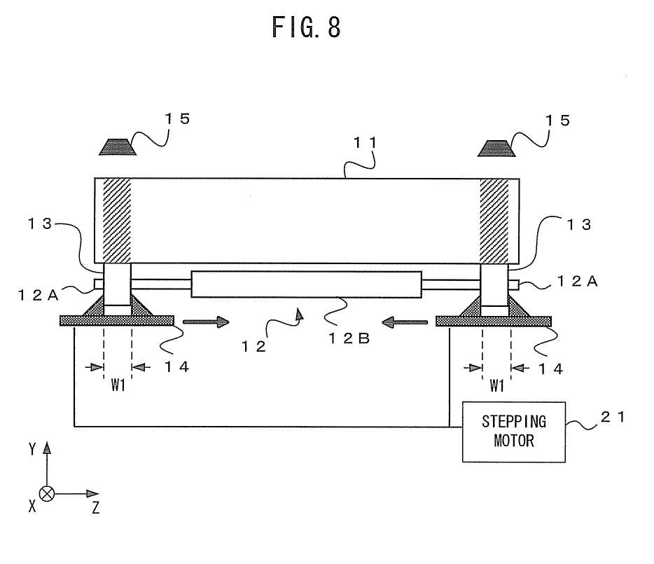

The configuration of the image processing apparatus according to the third embodiment is shown in FIG. 8. The image processing apparatus according to the third embodiment includes optical sensors 15 configured to irradiate at least the contact surface of the photoconductive layer surface of the photoconductive member 11. The optical sensors 15 are set near a circumferential direction of the contact surface between the photoconductive member 11 and the gap keeping members 13 and move in association with the moving members 14. As a method of moving the optical sensors 15 in association with the moving members 14, an implementation is also possible in which the optical sensors 15 acquire a driving amount from the stepping motor 21 and move in a direction and a distance same as those of the moving members 14 or the moving members 14 and the optical sensors 15 are fixed. Components other than the optical sensors 15 are the same as those in the first embodiment (see FIGS. 1 and 2).

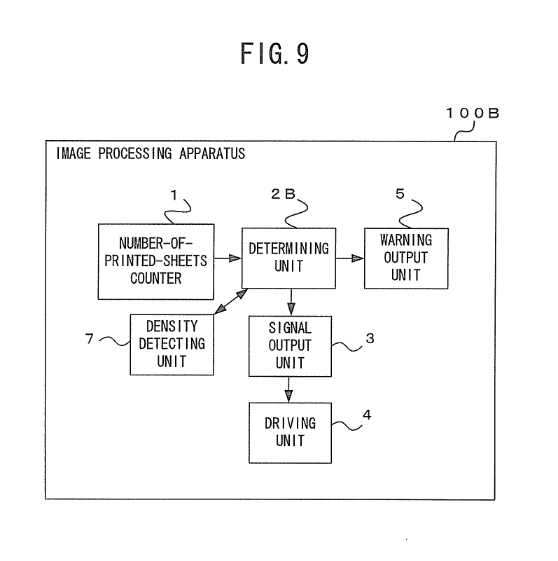

A block diagram of the image processing apparatus according to the third embodiment is shown in FIG. 9. An image processing apparatus 100B includes a density detecting unit 7 configured to detect the density of reflection from the photoconductive layer surface of the photoconductive member 11. The density detecting unit 7 corresponds to the optical sensors 15 shown in FIG. 8. In addition to the function of the determining unit 2 explained in the first embodiment, a determining unit 2B acquires a reflection density value (a measured value) of the photoconductive layer surface of the photoconductive member 11 obtained by the density detecting unit 7 and determines, on the basis of a specified value stored in the memory 112 in advance and the measured value, whether the measured value is within a specified range. The specified value may be, for example, a value (an initial value) measured before the shipment of the image processing apparatus 100B or a design value may be adopted as the specified value. Components other than the components explained above are the same as those in the first embodiment (see FIG. 3).

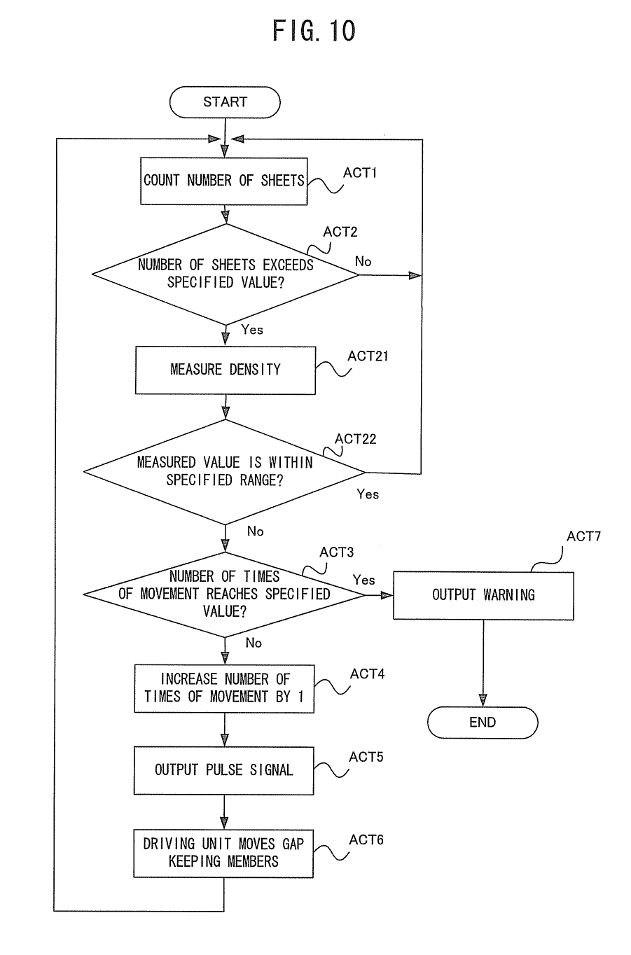

An operation example of the image processing apparatus 100B is shown in a flowchart of FIG. 10. If it is determined in the determination of the number of sheets in ACT 2 that the number of printed sheets exceeds the specified value (Yes in ACT 2), the density detecting unit 7 measures the density of reflection from the photoconductive layer surface of the photoconductive member 11 (ACT 21). The determining unit 2B acquires a measured value from the density detecting unit 7 and determines, on the basis of the measured value and the specified value stored in the memory 112, whether the measured value is within the specified range (ACT 22). In ACT 22, the determining unit 2B calculates a difference between the measured value and the specified value and compares a difference value and a threshold to determine whether the measured value is within the specified range. If the determining unit 2B determines that the measured value is within the specified range (Yes in ACT 22), the processing returns to ACT 1. If the determining unit 2B determines that the measured value is outside the specified range (No in ACT 22), the processing proceeds to the determination of the number of times of movement in ACT 3. When the moving members 14 move, in order to suppress only fixed sections from being always detected (prevent the optical sensors 15 from applying, after the movement of the moving members 14, detection processing to sections before the movement), the optical sensors 15 move in a direction and a distance same as those of the moving members 14.

The third embodiment is the same as the first embodiment other than the above explanation.

In the example explained above, a method of measuring the density of reflection using the optical sensors is adopted. However, an implementation is also possible in which a distance to the photoconductive layer is measured using a distance sensor to detect wear of the photoconductive layer surface.

An implementation is also possible in which the configuration explained in the second embodiment and the configuration explained in the third embodiment are combined.

In the embodiments, as an example of a method of shifting contact sections, the photoconductive member 11 is fixed and the gap keeping members 13 are moved. However, the gap keeping members 13 may be fixed and the photoconductive member 11 may be moved. The photoconductive member 11 and the gap keeping members 13 may be moved in directions different from each other.

As explained above in detail, with the technique described in this specification, it is possible to keep a gap between the photoconductive member and the electric resistance adjusting layer of the charging roller constant and prevent charging unevenness of the photoconductive member.

While certain embodiments have been described, these embodiments have been presented by way of example only, and are not intended to limit the scope of invention. Indeed, the novel apparatus and methods described herein may be embodied in a variety of other forms; furthermore, various omissions, substitutions and changes in the form of the apparatus and methods described herein may be made without departing from the spirit of the inventions. The accompanying claims and their equivalents are intended to cover such forms or modifications as would fall within the scope and spirit of the inventions.

What is claimed is:

1. An image processing apparatus comprising:
an image bearing member;
a charging roller configured to charge the image bearing member;
a gap keeping member configured to come into contact with an outer circumferential surface of the image bearing member and keep a distance between the outer circumferential surface of the image bearing member and an electric resistance adjusting layer of the charging roller;
a determining unit configured to determine whether a contact section between the outer circumferential surface of the image bearing member and the gap keeping member is worn; and
a driving unit configured to shift, if the determining unit determines that the contact section is worn, a contact position between the outer circumferential surface of the image bearing member and the gap keeping member.

2. The apparatus according to claim 1, wherein the determining unit acquires a cumulative count value of a number of printed sheets and determines, if the count value exceeds a specified value, that the contact section is worn.

3. The apparatus according to claim 1, wherein the determining unit acquires a value or values of one or both of an electric current and a voltage between the image bearing member and the charging roller and determines, if the value is not within a specified range or the values are not within specified ranges, that the contact section is worn.

4. The apparatus according to claim 3, wherein the determining unit acquires a value or values of the one or both of the electric current and the voltage between the image bearing member and the charging roller during power-on of the image processing apparatus or return from a sleep state of the image processing apparatus and determines whether the contact section is worn.

5. The apparatus according to claim 1, wherein the determining unit measures density of reflection from the contact section of the image bearing member using a sensor and determines, if a measured value of the density of reflection is not within a specified range, that the contact section is worn.

6. The apparatus according to claim 1, further comprising a notifying unit configured to notify a message, wherein
the determining unit determines whether a number of times the contact position is shifted reaches a predetermined number of times, and
the notifying unit issues, if the determining unit determines that the number of times reaches the predetermined number of times, notification for urging replacement of a device.

7. The apparatus according to claim 1, wherein the driving unit moves the gap keeping member in a horizontal direction of a rotation axis of the image bearing member to shift the contact position between the outer circumferential surface of the image bearing member and the gap keeping member.

8. The apparatus according to claim 7, wherein the driving unit moves the gap keeping member a distance equal to or larger than width of the contact section.

9. The apparatus according to claim 7, wherein
the determining unit measures density of reflection from the contact section of the image bearing member using a sensor and determines, if a measured value of the density of reflection is not within a specified range, that the contact section is worn, and
the sensor moves in a direction and a distance as those of the gap keeping member.

10. The apparatus according to claim 1, wherein the determining unit determines, if a cumulative operation time of the apparatus exceeds a fixed period, that the contact section is worn.

11. A charging device comprising:
a charging roller configured to charge an image bearing member;
a gap keeping member configured to come into contact with an outer circumferential surface of the image bearing member and keep a distance between the outer circumferential surface of the image bearing member and an electric resistance adjusting layer of the charging roller;
a determining unit configured to determine whether a contact section between the outer circumferential surface of the image bearing member and the gap keeping member is worn; and
a driving unit configured to shift, if the determining unit determines that the contact section is worn, a contact position between the outer circumferential surface of the image bearing member and the gap keeping member.

12. The device according to claim 11, wherein the determining unit acquires a cumulative count value of a number of printed sheets and determines, if the count value exceeds a specified value, that the contact section is worn.

13. The device according to claim 11, wherein the determining unit acquires a value or values of one or both of an electric current and a voltage between the image bearing member and the charging roller and determines, if the value is not within a specified range or the values are not within specified ranges, that the contact section is worn.

14. The device according to claim 11, wherein the determining unit measures density of reflection from the contact section of the image bearing member using a sensor and determines, if a measured value of the density of reflection is not within a specified range, that the contact section is worn.

15. The device according to claim 11, wherein
the determining unit determines whether a number of times the contact position is shifted reaches a predetermined number of times, and
a notifying unit issues, if the determining unit determines that the number of times reaches the predetermined number of times, notification for urging replacement of a device.

16. A charging roller control method for an image processing apparatus including an image bearing member, a charging roller configured to charge the image bearing member, and a gap keeping member configured to come into contact with an outer circumferential surface of the image bearing member and keep a distance between the outer circumferential surface of the image bearing member and an electric resistance adjusting layer of the charging roller,
the method comprising:
determining whether a contact section between the outer circumferential surface of the image bearing member and the gap keeping member is worn; and
shifting, if it is determined that the contact section is worn, a contact position between the outer circumferential surface of the image bearing member and the gap keeping member.

17. The method according to claim 16, wherein the image processing apparatus acquires a cumulative count value of a number of printed sheets and determines, if the count value exceeds a specified value, that the contact section is worn.

18. The method according to claim 16, wherein the image processing apparatus acquires a value or values of one or both of an electric current and a voltage between the image bearing member and the charging roller and determines, if the value is not within a specified range or the values are not within specified ranges, that the contact section is worn.

19. The method according to claim 16, wherein the image processing apparatus measures density of reflection from the contact section of the image bearing member using a sensor and determines, if a measured value of the density of reflection is not within a specified range, that the contact section is worn.

20. The method according to claim 16, wherein the image processing apparatus determines whether a number of times the contact position is shifted reaches a predetermined number of times and issues, if the image processing apparatus determines that the number of times reaches the predetermined number of times, notification for urging replacement of a device.
